(19) United States
(12) Patent Application Publication
(10) Pub. No.: US 2025/0266591 A1
(43) Pub. Date: Aug. 21, 2025

(54) SENSOR AND METHOD FOR INDICATING ADVERSE THERMAL EVENT IN A CELL OF A BATTERY SYSTEM

(71) Applicant: Caterpillar Inc., Peoria, IL (US)

(72) Inventors: Siddartha Saikia, Chennai (IN); Luvkush Kumar, Mathura (IN)

(73) Assignee: Caterpillar Inc., Peoria, IL (US)

(21) Appl. No.: 18/925,122

(22) Filed: Oct. 24, 2024

Related U.S. Application Data
(63) Continuation of application No. 18/442,140, filed on Feb. 15, 2024.

(51) Int. Cl. H01M 50/581; H01M 10/04; H01M 10/48

(52) U.S. Cl. CPC H01M 50/581; H01M 10/486; H01M 10/0481; H01M 2200/103

(57) ABSTRACT

A battery system includes a cell. The cell includes a including a housing. The housing includes a plurality of walls that define an outer surface of the housing. The housing also includes a sensor coupled to the outer surface of the housing and configured to indicate an adverse thermal event in the cell. The sensor includes a deformable element made of a shape-memory material (SMM) and has a pre-stressed shape. The deformable element is adapted to deform to a memorized shape from the pre-stressed shape in response to an operating temperature of the cell exceeding a predefined temperature threshold for the cell. The memorized shape of the deformable element is different from the pre-stressed shape of the deformable element. A deformity of the deformable element from the pre-stressed shape to the memorized shape is indicative of the adverse thermal event in the cell.

### CROSS-REFERENCE TO PRIOR APPLICATIONS

This application is a Continuation in part of U.S. Ser. No. 18/442,140, filed Feb. 15, 2024, the contents of which are incorporated by reference.

### TECHNICAL FIELD

The present disclosure relates to a battery system including a cell, a sensor for indicating an adverse thermal event in the cell, and a method for indicating the adverse thermal event in the cell.

### BACKGROUND

Battery systems are used in various applications such as in energy storage systems, work machines, or electric vehicles to store and provide operating power. Each of these battery systems have multiple cells therein, arranged either in parallel, in series or in combinations thereof. These cells may be sensitive to temperature. It may be preferable to operate these cells below their maximum operating temperature. Above the maximum operating temperature for a particular cell, a performance of the cell may deteriorate, or the cell may altogether fail. For example, under heavy load conditions, an increase in current demand from the cells may lead to heating of the cells. If a temperature of the cell exceeds the maximum operating temperature, an adverse thermal event may occur in the cell, that, in turn, may lead to a failure of the cell and consequently, the battery system. These adverse thermal events may include an overheating event, a fire originating from one or more cells, and/or a thermal runaway event.

Conventional cells have a separator that is configured to disable the corresponding cell when the temperature of the cell exceeds the maximum operating temperature. The separator may allow exchange of ions between a cathode and an anode of the cell, via the separator, at temperatures below the maximum operating temperature and may prevent exchange of ions through the separator at temperatures above the maximum operating temperature, thereby preventing adverse thermal events in most cases. For example, the separator may melt at the maximum operating temperature, permanently disabling the cell. An example of such a separator is a tri-layer cell separator including a layer of polyethylene between two layers of polypropylene. In an event that a cell undergoes such a failure, a service technician would be able to identify and replace such disabled cells.

It is also known to identify disabled cells by measuring an impedance of the cells. However, if these cells are disposed in parallel, it may be challenging to measure the impedance of the individual cells. Moreover, although it is possible to measure impedance of individual cells that are connected in series, the process of repeating the measurement process for each cell can be time consuming. Often batteries are packaged in such a way that opening a battery pack for impedance measurements may be a time-consuming exercise.

As an alternative to measuring individual impedances of cells connected in series, it is known to monitor the temperature of the cell to determine whether the maximum operating temperature at which the separator melts has exceeded. This may be achieved by disposing a thermistor in each cell. However, incorporating a thermistor in each cell may be expensive and may increase overall costs associated with manufacturing the battery system.

PCT Publication 2023/279089, hereinafter referred to as ‘the '089 reference’, describes materials and systems to manage thermal runaway issues in a battery module. In the '089 reference, the battery module includes cells separated by spacer elements. To mitigate thermal runaway issues, spacer elements may be extended to the interior surface of the enclosure. A seal is formed between the spacer elements and the interior wall to form a thermal barrier between adjacent cells.

However, the spacer elements described in the '089 reference includes a heat activated material made from a shape memory element that flips upward when triggered by heat thereby blocking heat, fire, and other materials that are released during thermal runaway events to prevent thermal propagation between cells. Thus, the shape memory element is used to contain or mitigate thermal propagation in cells. The shape memory element described in the '089 reference directly mitigates risk associated with continued operation of the cell but, however, does so without providing an indication as to the occurrence of the adverse thermal event itself. Further, typically levels of current flow through a battery terminal, which makes it necessary for a direct current bus to be laser welded to the battery terminal to prevent arching.

### SUMMARY

In an aspect of the present disclosure, a battery system is disclosed. The disclosed battery system includes a cell. The cell includes a housing. The housing includes a plurality of walls that define an outer surface of the housing. The housing also includes a sensor coupled to the outer surface of the housing and configured to indicate an adverse thermal event in the cell. The sensor includes a deformable element made of a shape-memory material (SMM) and has a pre- stressed shape. The deformable element is adapted to deform to a memorized shape from the pre-stressed shape in response to an operating temperature of the cell exceeding a predefined temperature threshold for the cell. The memorized shape of the deformable element is different from the pre-stressed shape of the deformable element. A deformity of the deformable element from the pre-stressed shape to the memorized shape is indicative of the adverse thermal event in the cell.

In another aspect of the present disclosure, a sensor for indicating an adverse thermal event in a cell is disclosed. The disclosed sensor includes a deformable element made of a shape-memory material (SMM) and has a pre- stressed shape. The deformable element is formed as a wire. The deformable element is adapted to deform to a memorized shape from the pre-stressed shape in response to an operating temperature of the cell exceeding a predefined temperature threshold for the cell. The memorized shape of the deformable element is different from the pre-stressed shape of the deformable element. A deformity of the deformable element from the pre-stressed shape to the memorized shape is indicative of the adverse thermal event in the cell.

In yet another aspect of the present disclosure, a method for indicating an adverse thermal event in a cell is disclosed. The disclosed method includes coupling a sensor, including a deformable element made of a shape-memory material (SMM), to an outer surface of a housing of the cell. At least a segment of the deformable element is formed as a wire. The deformable element has a pre- stressed shape. The method also includes deforming the deformable element to a memorized shape from the pre-stressed shape when an operating temperature of the cell exceeds a predefined temperature threshold for the cell. The memorized shape of the deformable element is different from the pre-stressed shape of the deformable element. The method further includes indicating the adverse thermal event in the cell based on a deformity of the deformable element from the pre-stressed shape to the memorized shape.

Other features and aspects of this disclosure will be apparent from the following description and the accompanying drawings.

### BRIEF DESCRIPTION OF THE DRAWINGS

FIG. 1A is a schematic view of a battery system, according to an embodiment of the present disclosure;

FIG. 1B is a schematic view of a cell including a sensor, according to an embodiment of the present disclosure;

FIG. 2 is a schematic view of the sensor for the battery system of FIG. 1B, wherein a deformable element of the sensor is in a pre-stressed shape;

FIG. 3A is a schematic view of an exemplary deformable element in a pre-stressed shape, according to an embodiment of the present disclosure;

FIG. 3B is a schematic view of the deformable element of FIG. 3A in a memorized shape;

FIG. 3C is a schematic view of an exemplary deformable element in a pre-stressed shape, according to another embodiment of the present disclosure;

FIG. 3D is a schematic view of the deformable element of FIG. 3C in a memorized shape;

FIG. 3E is a schematic view of another exemplary deformable element, according to yet another embodiment of the present disclosure;

FIG. 4 is a schematic view of the deformable element of the sensor of FIG. 2 in a memorized shape;

FIG. 5 is a schematic view of an array of sensors to indicate adverse thermal events in corresponding cells of a battery system, according to an embodiment of the present disclosure; and

FIG. 6 is a flowchart of a method for indicating an adverse thermal event in the cell, according to an embodiment of the present disclosure.

### DETAILED DESCRIPTION

Wherever possible, the same reference numbers will be used throughout the drawings to refer to the same or like parts.

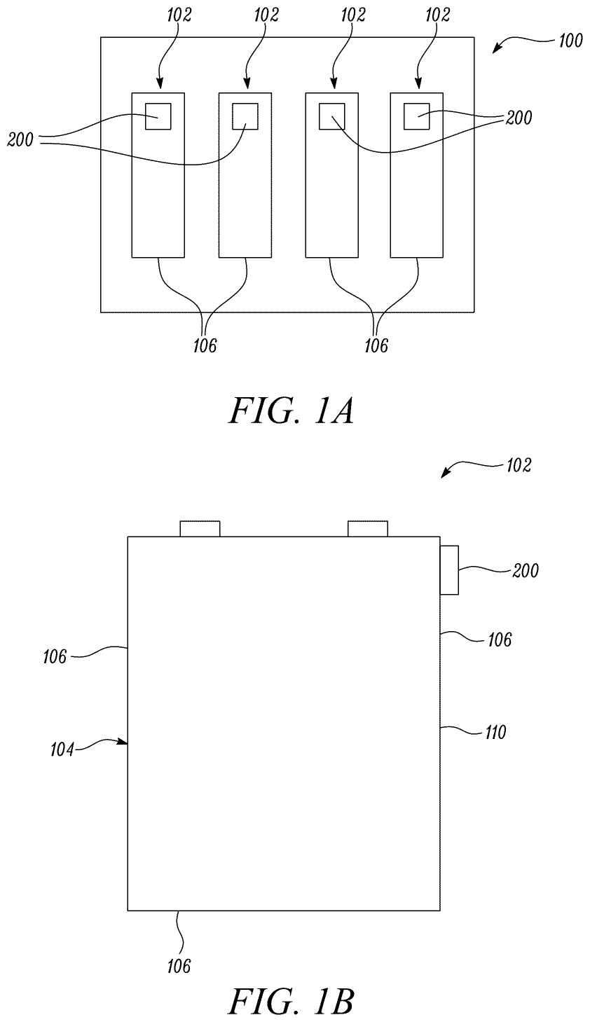

Referring to FIG. 1A, a schematic view of an exemplary battery system 100 is illustrated. The battery system 100 is typically used to store electrical power and distribute the stored electrical power at a desired power output and a desired voltage output. In an example, the battery system 100 may be used in energy storage systems. In another example, the battery system 100 may supply electrical power to a moving machine or a stationary machine, such as, a work or construction machine.

The battery system 100 includes a number of cells 102. The number of cells 102 may be arranged in series, in parallel, or in a combination of parallel and series, without limiting the scope of the present disclosure. Four cells 102 are shown in FIG. 1 as an example. In the illustrated embodiment of FIG. 1A, the cells 102 are embodied as a lithium-ion cell. Alternatively, the cell 102 may include any other type of cell such as a lead-acid cell, a nickel metal hydride cell, or other types of cells known in the art. The cell 102 includes a housing 104. Each cell 102 includes a respective housing 104 that mechanically separates the individual cells 102 from one another.

Referring now to FIG. 1B, a schematic view of a single cell 102 is illustrated. The housing 104 includes a number of walls 106 that define an outer surface 110 of the housing 104. Further, an enclosed space (not shown) is defined within the number of walls 106. The cell 102 also includes a cell unit (not shown) disposed within the enclosed space of the housing 104. The cell unit may include an anode, a cathode, and an electrolyte disposed between the anode and the cathode. In some examples, the anode may be made of graphite into which lithium can be incorporated. The cathode may be made of lithium cobalt (III) oxide (LiCoO₂), lithium-nickel-manganese-cobalt oxides, and other materials known to a person having ordinary skill in the art. The electrolyte may include a lithium salt dissolved in a specific solvent for example, ethylene carbonate (EC), diethyl carbonate (DEC), dimethyl carbonate (DMC), propylene carbonate (PC), or the like. In an example, during discharging of the cell 102, lithium may be oxidized at the anode and may be migrated through the electrolyte towards the cathode. Conversely, during charging of the cell 102, the reverse process may take place.

In some examples, the cell 102 may, during operation, trigger an endothermic reaction in the active material, for example, in the anode, the cathode, or the electrolyte arranged between them, in response to an undesired adverse thermal event. It should be noted that the type, construction, and composition details of the cell 102 as mentioned herein are exemplary in nature, and the cell 102 may be of any known type and include any other construction and cell composition known to persons skilled in the art.

The battery system 100 also includes a sensor 200 coupled to the outer surface 110 of the housing 104 of the cell 102. In use, the sensor 200 may be placed adjacent to a region of the cell 102 that is visible in an event that the battery system 100 is opened. For example, the sensor 200 may be placed adjacent to a top rim of the cell 102. The sensor 200 may be placed such that it may be easy to access.

The sensor 200 is configured to indicate an adverse thermal event, if any, in the cell 102. Stated differently, if the cell 102 of the battery system 100 experiences any adverse event, especially, a thermally adverse event e.g., overheating beyond a specific threshold, then the sensor 200 is configured to detect such event and provide indication, visually or through other means, of the event. The adverse thermal event in the cell 102 may include an overheating event, a fire originating from one or more cells 102 or a thermal runaway event without any limitations. The thermal runaway event is a phenomenon in which a particular cell enters a self-heating mode.

In one example, the cell 102 may be designed to operate in a temperature range of 60° C. (C) to 75° C. However, an adverse thermal event such as the thermal runaway event may occur in the cell 102 when the cell 102 operates in a temperature range of 80° C. to 110° C. which exceeds the recommended design and standard operating conditions of 60° C. to 75° C. It is to be noted that the operating temperature values of 60-75° C. for the cell 102 disclosed herein is merely exemplary in nature. The specific operating temperatures of each cell 102 may vary from one application to another based on various factors including, but not limited to, battery composition and cell chemistry.

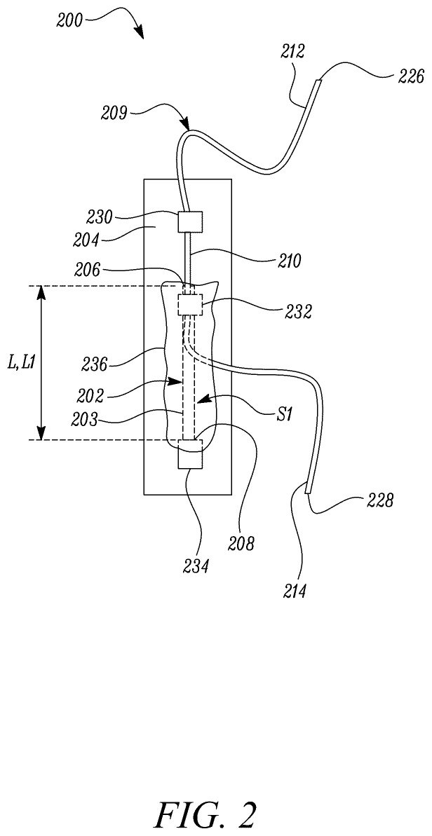

Referring to FIG. 2, a schematic of the battery system 100 including the sensor 200 is illustrated. The sensor 200 includes a deformable element 202. The deformable element 202 is a heat sensitive element herein. The deformable element 202 is made of a shape-memory material (SMM) and has a pre-stressed shape S1. The pre-stressed shape S1 is a natural resting shape of the deformable element 202 that is retained by the deformable element 202 at ambient temperature and pressure conditions. In some examples, the pre-stressed shape S1 is retained when the cell 102 (see FIG. 1B) is operating within a predefined temperature threshold for the cell 102. The term “shape” as used herein relates to a form, a posture, or an orientation of an element defined along a length of the corresponding element. Further, the term “shape” does not include a cross-section of the corresponding element. The term “predefined temperature threshold” as used herein may refer to a temperature above which the cell 102 may be susceptible to one or more adverse thermal events. In embodiments herein, it is envisioned that the predefined temperature threshold is greater than ambient temperature conditions and may lie in a range of 80° C. to 110° C. The ambient temperature conditions include conditions in which the cell 102 is likely to be stored or operated during a charge and/or discharge event/cycle.

In an example, the predefined temperature threshold may lie in a range of 85° C. to 90° C., 90° C. to 95° C., or 95° C. to 100° C. The range of the predefined temperature threshold may vary from one application to another depending on a type of the cell 102 and, for example, based on a maximum state of charge of the cell 102 or cell capacity.

The SMM of the deformable element 202 is a shape-memory alloy (SMA). The shape-memory alloy may be an alloy made of one or more metallic materials or one or more polymers. In some examples, the SMA may include copper-aluminum-nickel alloy, nickel-titanium (NiTi) alloy, or an alloy based on zinc, copper, gold, and iron. In other examples, the SMM of the deformable element 202 is a shape-memory polymer. The shape-memory polymer may include, for example, thermoplastic or thermoset (covalently cross-linked) polymers. It should be noted that the present disclosure is not limited by a type of alloy used to make the SMM. Rather, the present disclosure is applicable regardless of the type or nature of the alloys that are currently known in the art as well as those that may be developed in the future and used in producing/manufacturing the SMM for use, in part, as the sensor 200 of the present disclosure.

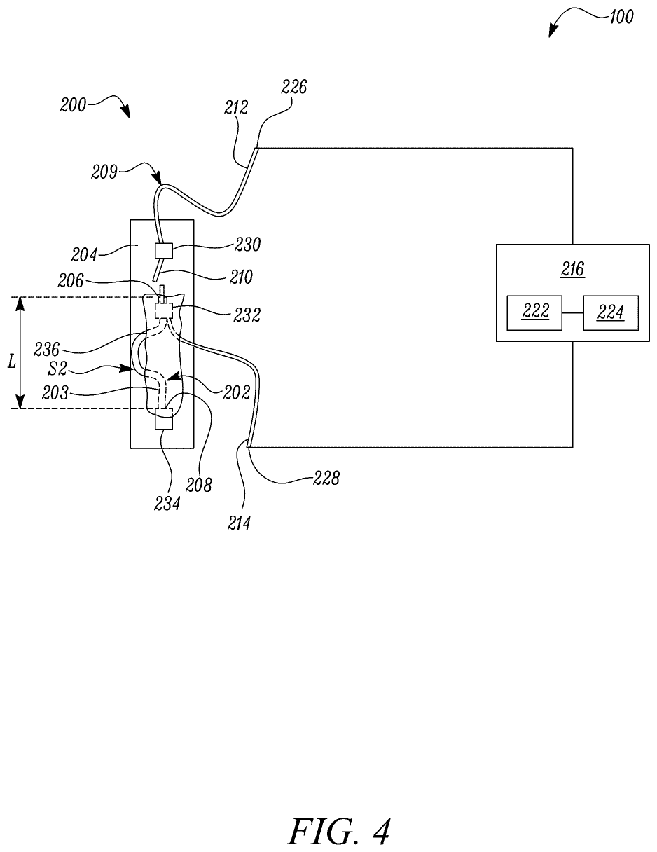

The deformable element 202 defines a first end 206 and a second end 208. The deformable element 202 defines a length L between the first and second ends 206, 208. The second end 208 is defined opposite the first end 206. At least a segment of the deformable element 202 is formed as a wire 203. In the illustrated embodiment of FIG. 2, the deformable element 202 is formed as the wire 203. In other words, the wire 203 extends from the first end 206 to the second end 208. It should be noted that the wire 203 of the deformable element 202 transforms from the pre-stressed shape S1 to a memorized shape S2 (shown in FIG. 4). Further, the wire 203 defines a length L1. In the illustrated embodiment of FIG. 2, the length L is equal to the length L1, as the entire deformable element 202 is formed as the wire 203.

Further, in the illustrated embodiment of FIG. 2, the pre-stressed shape S1 of the deformable element 202 is linear. Alternatively, the deformable element 202 may have any other shape e.g., curved, angled, or curvilinear, based on specific requirements of an application. It should be noted that, in the present disclosure, the term “the pre-stressed shape S1 of the deformable element 202” relates to the pre-stressed shape S1 of the wire 203 which is made of the SMM. Further, the term “the memorized shape S2 of the deformable element 202” relates to the memorized shape S2 of the wire 203 which is made of the SMM. The wire 203 consists of or is composed of a single strand or multiple strands. Further, the wire 203 may have an elliptical cross-section, a circular cross-section, a square cross-section, a rectangular cross-section, or any other cross section known to persons skilled in the art. It should be noted that the present disclosure is not limited to a type of the wire 203, dimensions of the wire 203, or a cross-section of the wire 203.

Referring again to FIG. 2, it should be noted that a transition temperature of the SMM of the deformable element 202 may be selected or tuned based on a value of the predefined temperature threshold for the cell 102. The term “transition temperature” as used herein is a temperature at which the deformable element 202 transitions from the pre-stressed shape S1 to the memorized shape S2. Further, the length L of the deformable element 202, the cross-section of the deformable element 202, and/or other parameters of the wire 203 or the deformable element 202 may be selected to achieve the deformation of the deformable element 202 at the transition temperature. In some cases, a material of the SMM may be chosen based on the predefined temperature threshold for the cell 102. In some examples, the transition temperature for the SMM may lie between 85° C. to 90° C., 90° C. to 95° C., or 95° C. to 100° C., without limiting the scope of the present disclosure.

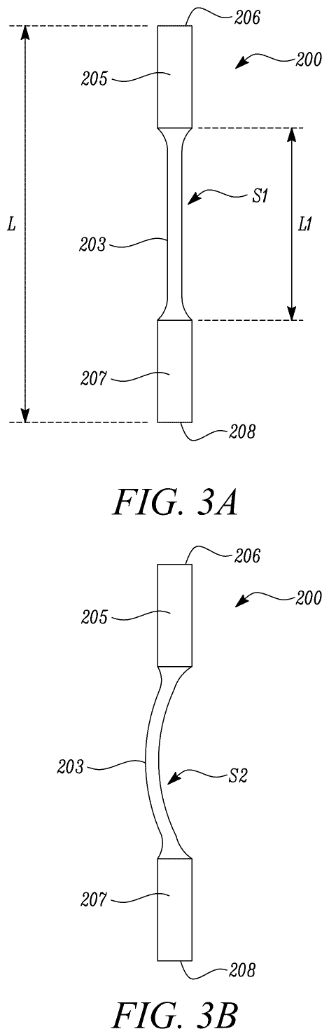

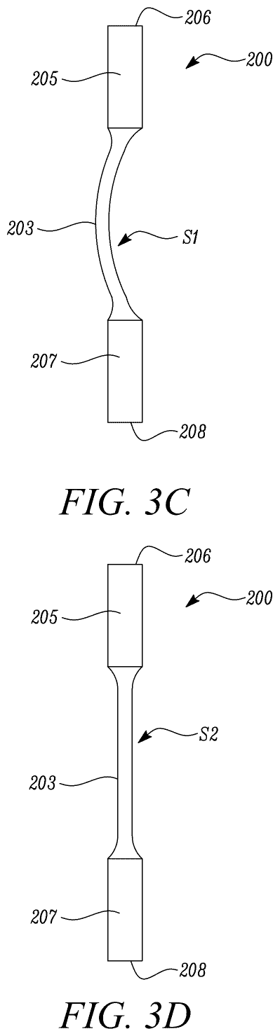

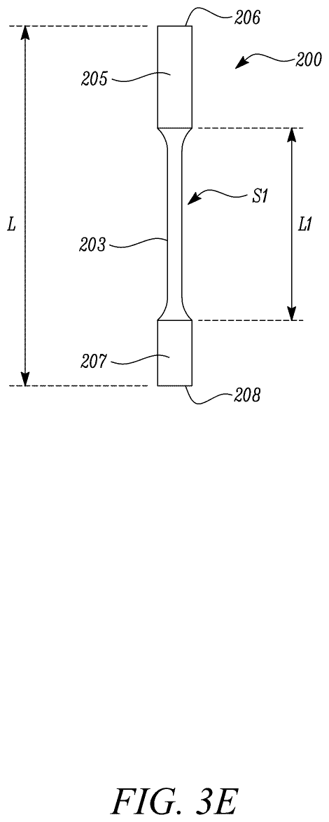

In some examples, as shown in FIG. 3A, the wire 203 is disposed midway along the length L of the deformable element 202. The length LI of the wire 203 is less than the length L of the deformable element 202. In such examples, the deformable element 202 includes the wire 203, a remaining portion 205, and a remaining portion 207. Further, the remaining portion 205 is equal to the remaining portion 207 as the wire 203 is disposed midway along the length L. In one example, the wire 203 and the remaining portions 205, 207 may be made of the same material. In another example, the wire 203 and the remaining portions 205, 207 may be made of different materials. Furthermore, when the deformable element 202 is in the pre- stressed shape S1, the wire 203 is co-axial or in alignment with a remaining portion 205, 207 of the deformable element 202. In other embodiment, as shown in FIG. 3C, when in the pre-stressed shape S1, the wire 203 may be bent away from the remaining portion 205, 207 of the deformable element 202. Further, as shown in FIG. 3D, upon reaching the predefined temperature threshold, the wire 203 may bend towards and become co-axial with the remaining portions 205, 207 of the deformable element 202.

In another example, as shown in FIG. 3E, the wire 203 may be disposed partway along the length L of the deformable element 202. In such examples, the remaining portion 205 and the remaining portion 207 are different in lengths as the wire 203 is disposed partway along the length L. The length L1 of the wire 203 is less than the length L of the deformable element 202.

As shown in FIG. 4, the sensor 200 also includes a substrate 204 to mechanically couple the sensor 200 to the outer surface 110 (see FIG. 1B) of the housing 104 (see FIG. 1B). The deformable element 202 is in contact with the substrate 204. The substrate 204 is made from a thermally conductive material. In one example, the substrate 204 may be made of a metal. In another example, the substrate 204 may be made of an alloy. However, it is to be noted that a type of material used to form the substrate 204 may depend on specific requirement of an application.

In the illustrated embodiment of FIG. 2, the substrate 204 is rectangular in shape. However, in other embodiments, the substrate 204 may have any other shape known to persons skilled in the art. Materials and form factor of the substrate 204 may be selected and the substrate 204 itself may be designed such that it would be configured to support various components of the sensor 200 including the deformable element 202 thereon. In one example, the remaining portions 205, 207 (see FIGS. 3A and 3B) of the deformable element 202 may be provided with an adhesive layer e.g., adhesive tapes, adhesive coatings, or other adhesion means to adhere with the outer surface 110 of the housing 104 of the corresponding cell 102.

The sensor 200 further includes a conductive wire 209 that contacts the deformable element 202. In an example, the conductive wire 209 may be a thin, enameled wire. Further, the conductive wire 209 may be made of, for example, tin, lead, silver, copper, zinc, or aluminum. The conductive wire 209 may be made of an alloy including one or more of, for example, copper, zinc, lead, tin, silver, and aluminum.

When in use, a current path is established along the conductive wire 209. The conductive wire 209 defines a fuse segment 210, a first electrode 212, and a second electrode 214. The first electrode 212 is defined at one end 226 of the conductive wire 209. The second electrode 214 is defined at an opposing end 228 of the conductive wire 209. The first and second electrodes 212, 214 help facilitate connection of the conductive wire 209 to a device, a circuit, or a controller for measuring an electrical resistance across the sensor 200.

The sensor 200 further includes a first coupling element 230 to couple the conductive wire 209 with the substrate 204. The first coupling element 230 may include a fastener. In some examples, the first coupling element 230 may include a stud formed from a thermoplastic material or a metal. Moreover, the sensor 200 includes a second coupling element 232 to couple the deformable element 202 with the conductive wire 209 at the first end 206 of the deformable element 202. The second coupling element 232 may include a clamp. In some examples, the second coupling element 232 may include a clamp formed from a thermoplastic material or a metal. It should be noted that the second coupling element 232 is not coupled or anchored to the substrate 204. The fuse segment 210 is defined between the first coupling element 230 and the second coupling element 232. The fuse segment 210 is held taut between the first and second coupling elements 230, 232.

The sensor 200 further includes a third coupling element 234 to couple the deformable element 202 with the substrate 204 at the second end 208 of the deformable element 202. The third coupling element 234 may include a fastener. In some examples, the third coupling element 234 may include a stud formed from a thermoplastic material or a metal.

The sensor 200 further includes a thermally conductive agent 236 disposed around the deformable element 202 to retain the deformable element 202 in contact with the substrate 204. The thermally conductive agent 236 keeps the deformable element 202 close to the housing 104 (see FIG. 1B). Moreover, the thermally conductive agent 236 allows heat, from the housing 104, to reach the deformable element 202. The thermally conductive agent 236 may completely enclose the deformable element 202 so that the deformable element 202 is in contact with the substrate 204. In some examples, the thermally conductive agent 236 may also enclose the second coupling element 232. Moreover, the thermally conductive agent 236 may also partially enclose the third coupling element 234. The thermally conductive agent 236 includes a glue or paste that retains the deformable element 202 in contact with the substrate 204. The thermally conductive agent 236 may include, for example, epoxy compounds.

Referring now to FIG. 4, the deformable element 202 deforms to the memorized shape S2 from the pre-stressed shape S1 (see FIG. 2) in response to the operating temperature of the cell 102 exceeding the predefined temperature threshold for the cell 102. The memorized shape S2 of the deformable element 202 is different from the pre-stressed shape SI of the deformable element 202. The memorized shape S2 may be a curvilinear shape, a hook shape, or a U-shape or any other shape known to persons skilled in the art. In the illustrated embodiment of FIG. 4, the memorized shape S2 is the hook shape. Alternatively, the memorized shape S2 disclosed herein may include any other shape, for example, spiral or helical to suit specific requirements of an application. In some examples, as shown in FIGS. 3A and 3B, upon deforming to the memorized shape S2, the wire 203 may be misaligned relative to the remaining portion 205, 207 of the deformable element 202.

Referring again to FIG. 4, as the conductive wire 209 and the wire 203 are held in tension, the conductive wire 209 breaks under any additional strain that is exerted by the wire 203 of the deformable element 202, which causes the fuse segment 210 to break. Thus, the deformable element 202 breaks the fuse segment 210 based on a deformity of the deformable element 202 from the pre-stressed shape S1 to the memorized shape S2. In other words, the deformable element 202 may curl to the memorized shape S2 when the operating temperature of the cell 102 exceeds the predefined temperature threshold for the cell 102, thereby snapping the conductive wire 209.

The deformity of the deformable element 202 from the pre-stressed shape S1 to the memorized shape S2 is indicative of the adverse thermal event in the cell 102. The adverse thermal event in the cell 102 is indicated based on a visual inspection of the deformity of the deformable element 202 i.e., when the deformable element 202 has deformed from the pre-stressed shape S1 and currently exhibits the memorized shape S2. As disclosed earlier herein, the deformation of the deformable element 202 to the memorized shape S2 is triggered as a response when the operating temperature of the cell 102 exceeds the predefined temperature threshold, and is therefore visually indicative of, the adverse thermal event. Thus, service technicians may determine if the cell 102 has experienced the adverse thermal event based on the visual inspection of the deformable element 202. Therefore, if the service technicians observe that the deformable element 202 has changed to the memorized shape S2, the personnel may conclude that the cell 102 has experienced at least one of the many types of adverse thermal events known to persons skilled in the art for at least potentially causing one or more types of current, or future, failures e.g., mechanical, such as, structural, chemical, electrical or all in respective ones of the cell(s) 102 or the overall battery system 400.

The battery system 100 further includes a controller 216. In an example, the controller 216 may indicate occurrence of the adverse thermal event in the cell 102 based on breaking of the conductive wire 209 of the sensor 200. The first and second electrodes 212, 214 are in communication with the controller 216. The controller 216 measures an electrical resistance across the conductive wire 209 of the sensor 200 to indicate the adverse thermal event in the cell 102.

The controller 216 includes one or more memories 222 to store information pertaining to the predefined temperature threshold of the cell 102. The memories 222 may include any means of storing information, including a hard disk, an optical disk, a floppy disk, ROM (read only memory), RAM (random access memory), PROM (programmable ROM), EEPROM (electrically erasable PROM), or other computer-readable memory media known to persons skilled in the art.

The controller 216 also includes one or more processors 224 communicably coupled to the one or more memories 222. It should be noted that the one or more processors 224 may embody a single microprocessor or multiple microprocessors for receiving various input signals and generating output signals. Numerous commercially available microprocessors may perform the functions of the one or more processors 224. Each processor 224 may further include a general processor, a central processing unit, an application specific integrated circuit (ASIC), a digital signal processor, a field programmable gate array (FPGA), a digital circuit, an analog circuit, a microcontroller, any other type of processor, or any combination thereof. Each processor 224 may include one or more components that may be operable to execute computer executable instructions or computer code that may be stored and retrieved from the one or more memories 222.

Below the predefined temperature threshold, the electrical resistance across the conductive wire 209 of the sensor 200 may have a predetermined threshold resistance. The predetermined threshold resistance may be stored in the memories 222 of the controller 216. In an event that the sensor 200 is heated above the predefined temperature threshold, the electrical resistance across the conductive wire 209 of the sensor 200 changes. The electrical resistance across the conductive wire 209 changes when the conductive wire 209 breaks due to a transition of the deformable element 202 to the memorized shape S2. Further, if the electrical resistance measured across the conductive wire 209 is above the predetermined threshold resistance, the controller 216 indicates that the adverse thermal event has occurred in the cell 102.

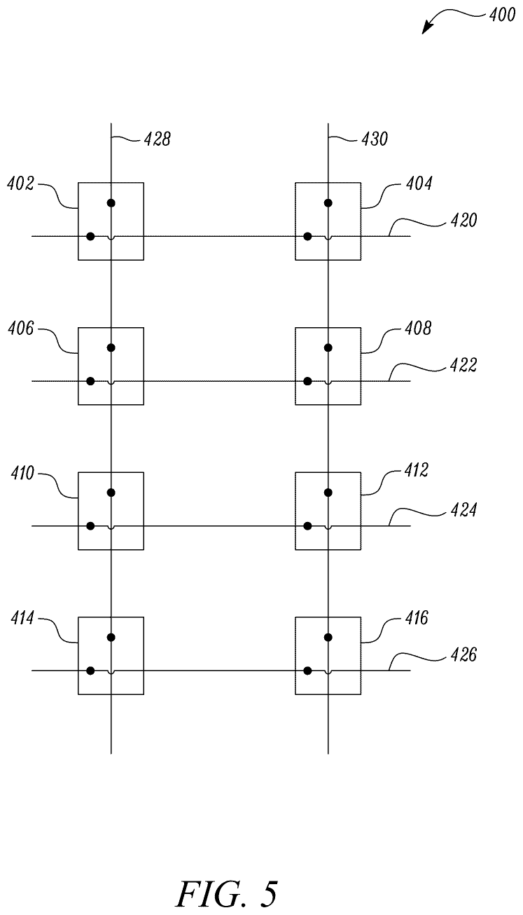

Referring now to FIG. 5, a schematic view of a battery system 400 is illustrated, according to an embodiment of the present disclosure. The battery system 400 is substantially similar to the battery system 100 illustrated in FIGS. 1 to 3, with common components being referred to by the same numerals. The battery system 400 has an array of sensors 402, 404, 406, 408, 410, 412, 414, 416 corresponding to a number of cells 102, each of which is same as the cell 102 shown and explained in relation to FIG. 1B. Further, each sensor 402, 404, 406, 408, 410, 412, 414, 416, 418 is similar in terms of construction, components, and functionality to the sensor 200 illustrated in FIGS. 1 to 3.

FIG. 5 shows the sensors 402, 404, 406, 408, 410, 412, 414, 416 arranged in an array of rows and columns, allowing each sensor 402, 404, 406, 408, 410, 412, 414, 416 to be addressed by row-column.

A first electrode (not shown herein) of the first (top) row of each sensor 402, 404 is connected to a first bus 420. A first electrode (not shown herein) of the second row of each sensor 406, 408 is connected to a second bus 422. A first electrode (not shown herein) of the third row of each sensor 410, 412 is connected to a third bus 424. A first electrode (not shown herein) of the fourth row of each sensor 414, 416 is connected to a fourth bus 426.

Further, a second electrode (not shown herein) of the first (left hand) column of each sensor 402, 406, 410, 414 is connected to a fifth bus 428. A second electrode (not shown herein) of the second column of each sensor 404, 408, 412, 416 is connected to a sixth bus 430. The point at which each sensor 402, 404, 406, 408, 410, 412, 414, 416 is connected to the respective bus 420, 422 424, 426, 428, 430 is shown by a dot. In this way, each sensor 402, 404, 406, 408, 410, 412, 414, 416 can be addressed individually to measure its electrical resistance. For example, the first bus 420 and the fifth bus 428 may be used to measure the electrical resistance of the sensor 402 and does not result in current flowing through other sensors 404, 406, 408, 410, 412, 414, 416.

The bus 420, 422 424, 426, 428, 430 may be connected to corresponding sensors 402, 404, 406, 408, 410, 412, 414, 416 such that the electrical resistance measurement is made in the plane of the sensors 402, 404, 406, 408, 410, 412, 414, 416, or such that the electrical resistance measurement is made through the sensors 402, 404, 406, 408, 410, 412, 414, 416, or in some other configuration.

The example illustrated in FIG. 5 shows eight sensors 402, 404, 406, 408, 410, 412, 414, 416 and six buses 420, 422 424, 426, 428, 430. Alternatively, the battery system 400 may include any number of sensors and buses, based on an electrical capacity of the battery system 400. Further, the sensors 402, 404, 406, 408, 410, 412, 414, 416 and the buses 420, 422 424, 426, 428, 430 may be arranged in a different configuration from that shown in FIG. 5. Any arrangement of the buses 420, 422 424, 426, 428, 430 that allows the electrical resistance of each sensor 402, 404, 406, 408, 410, 412, 414, 416 to be measured individually is possible.

Below the predefined temperature threshold, the electrical resistance across a fuse segment (not shown) of a corresponding sensor 402, 404, 406, 408, 410, 412, 414, 416 may have a predetermined threshold resistance. In an event wherein one or more of the sensors 402, 404, 406, 408, 410, 412, 414, 416 are heated to above the predefined temperature threshold, the electrical resistance across the fuse segment of the corresponding sensor 402, 404, 406, 408, 410, 412, 414, 416 changes. Further, the controller 216 (see FIG. 4) is in communication with each of the buses 420, 422 424, 426, 428, 430. In an event that the measured electrical resistance across the fuse segment of one or more sensors 402, 404, 406, 408, 410, 412, 414, 416 is above the predetermined threshold resistance, the controller 216 indicates that an adverse thermal event has occurred in the cell 102 of the corresponding sensor 402, 404, 406, 408, 410, 412, 414, 416.

A technician or service personnel may physically conduct a visual inspection to identify the cells 102 in the battery system 100 that have experienced adverse thermal events. Alternatively, a notification may be provided. In an example wherein the controller 216 indicates that the adverse thermal event has occurred in one or more of the cells 102, the notification may be provided to a user of the battery system 400. The notification may be sent to a user interface (not shown) and may include an electronic message or a wireless message, turning-on of a light or buzzer, or any other notification. The notification may be visual, audible, electronic, wireless, or otherwise.

It may be noted that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure as defined in the appended claims.

### INDUSTRIAL APPLICABILITY

The present disclosure describes the battery system 100, 400 including the sensor 200, 402, 404, 406, 408, 410, 412, 414, 416 to indicate the adverse thermal event in the cell 102. As described above, the sensor 200 includes the deformable element 202 that deforms to the memorized shape S2 from the pre- stressed shape S1 in response to the operating temperature of the cell 102 exceeding the predefined temperature threshold for the cell 102. The deformable element 202 is formed as the wire 203 herein. Owing to a construction of the deformable element 202 as the wire 203, as opposed to other forms, the wire 203 may be cost-effective and may reduce an overall cost of the sensor 200. Further, as shape memory alloys are readily available in the form of wires, the SMM wire 203 can be manufactured easily from shape memory alloys. Moreover, Owing to the construction of the deformable element 202 as the wire 203, as opposed to other forms, the sensor 200 described herein uses lesser quantity of the SMM wire 203, which may further reduce the cost of the sensor 200. The sensor 200 incorporating the SMM wire 203 as described herein is simple in construction and easy to manufacture.

The sensor 200, 402, 404, 406, 408, 410, 412, 414, 416 may allow service technicians to identify and locate cells 102 in which the operating temperature has exceeded the predefined temperature threshold. For example, the sensor 200, 402, 404, 406, 408, 410, 412, 414, 416 may be used to indicate whether one or more cells 102 have exceeded the operating temperature at which a separator is configured to disable the cell 102, so that any disabled cell 102 may be removed and replaced. In an example, the sensor 200, 402, 404, 406, 408, 410, 412, 414, 416 may be used to indicate whether the cell 102 has exceeded the predefined temperature threshold at which issues, such as, thermal runaway is known to arise. This may allow timely replacement of the cell 102.

In an example, the sensor 200, 402, 404, 406, 408, 410, 412, 414, 416 may be visually inspected to indicate the adverse thermal event in the cell 102. In another example, the controller 216 may be used to measure the electrical resistance across the one or more sensors 200, 402, 404, 406, 408, 410, 412, 414, 416 to indicate the adverse thermal event in the cell 102. In some examples, the electrical resistance may be measured by the controller 216 in a sequential manner to identify failed or disabled cells 102. Incorporation of the sensor 200, 402, 404, 406, 408, 410, 412, 414, 416 may improve safety of the cell 102 and may also reduce the time required to indicate adverse thermal events, especially in battery systems that include multiple cells arranged in a parallel configuration.

The sensor 200, 402, 404, 406, 408, 410, 412, 414, 416 may be retrofitted in existing battery systems. The sensor 200, 402, 404, 406, 408, 410, 412, 414, 416 may embody a compact sticker that can be easily affixed to the housing 104 of the cell 102.

The sensor 200, 402, 404, 406, 408, 410, 412, 414, 416 may improve battery management system estimation of the battery system 100, 400. For example, the sensor 200 may allow a more accurate estimation of various parameters associated with the cell 102 by analyzing the cell-level information such as voltage, temperature, and current. Further, the sensor 200, 402, 404, 406, 408, 410, 412, 414, 416 may improve reliability and serviceability of the cell 102 by aiding in determining the failure of one or more cells 102.

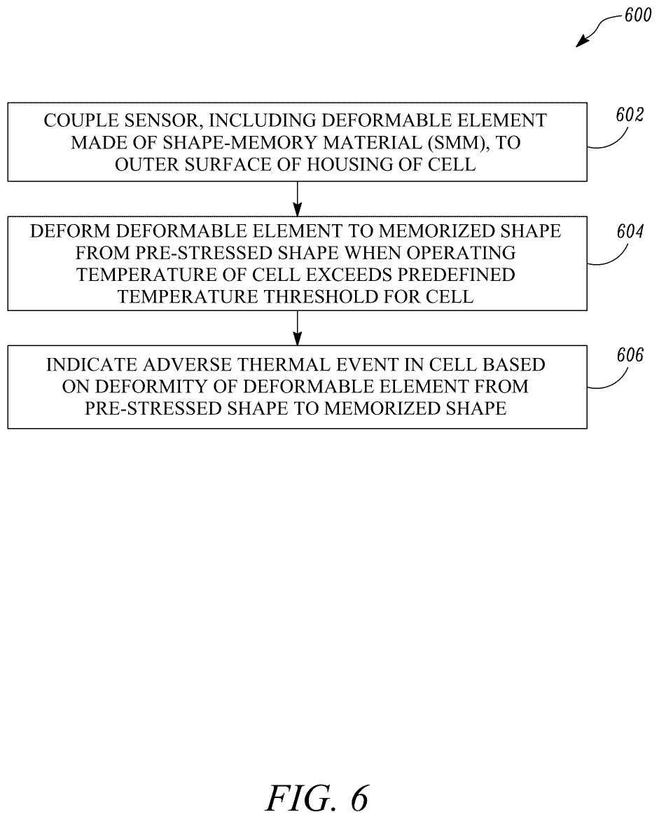

Referring to FIG. 6, a method 600 for indicating the adverse thermal event in the cell 102 is illustrated. With reference to FIGS. 1 to 3 and FIG. 6, at step 602, the sensor 200 including the deformable element 202 made of the shape-memory material (SMM) is coupled to the outer surface 110 of the housing 104 of the cell 102. At least the segment of the deformable element 202 is formed as the wire 203. The deformable element 202 has the pre-stressed shape S1.

At step 604, the deformable element 202 is deformed to the memorized shape S2 from the pre-stressed shape S1 when the operating temperature of the cell 102 exceeds the predefined temperature threshold for the cell 102. The memorized shape S2 of the deformable element 202 is different from the pre-stressed shape S1 of the deformable element 202. At step 606, the adverse thermal event in the cell 102 is indicated based on the deformity of the deformable element 202 from the pre- stressed shape S1 to the memorized shape S2.

The method 600 further includes a step (not shown) of coupling the sensor 200 to the outer surface 110 of the housing 104 using the substrate 204 of the sensor 200. The deformable element 202 is coupled to the substrate 204.

The sensor 200 includes the conductive wire 209 that contacts the deformable element 202. The conductive wire 209 defines the fuse segment 210, the first electrode 212, and the second electrode 214. The method 600 further includes a step (not shown) of breaking, by the deformable element 202, the fuse segment 210 based on the deformity of the deformable element 202 from the pre-stressed shape S1 to the memorized shape S2.

The method 600 further includes a step (not shown) of indicating the adverse thermal event in the cell 102 based on the visual inspection of the deformity of the deformable element 202 to the memorized shape S2 or measuring, by the controller 216, the electrical resistance across the fuse segment 210 to indicate the adverse thermal event in the cell 102.

While aspects of the present disclosure have been particularly shown and described with reference to the embodiments above, it will be understood by those skilled in the art that various additional embodiments may be contemplated by the modification of the disclosed work machine, systems, and methods without departing from the spirit and scope of the disclosure. Such embodiments should be understood to fall within the scope of the present disclosure as determined based upon the claims and any equivalents thereof.

What is claimed is:

1. A battery system comprising:
a cell including a housing, the housing including a plurality of walls that define an outer surface of the housing; and
a sensor coupled to the outer surface of the housing and configured to indicate an adverse thermal event in the cell, wherein:
the sensor includes a deformable element made of a shape- memory material (SMM) and has a pre-stressed shape,
the deformable element is adapted to deform to a memorized shape from the pre-stressed shape in response to an operating temperature of the cell exceeding a predefined temperature threshold for the cell,
the memorized shape of the deformable element is different from the pre-stressed shape of the deformable element, and
a deformity of the deformable element from the pre-stressed shape to the memorized shape is indicative of the adverse thermal event in the cell.

2. The battery system of claim 1, wherein at least a segment of the deformable element is formed as a wire.

3. The battery system of claim 2, wherein the wire consists of or is composed of: a single strand or multiple strands.

4. The battery system of claim 2, wherein the wire has one of an elliptical cross-section, a circular cross-section, a square cross-section, and a rectangular cross-section.

5. The battery system of claim 2, wherein the wire is disposed midway along a length of the deformable element.

6. The battery system of claim 2, wherein the wire is disposed partway along a length of the deformable element.

7. The battery system of claim 2, wherein, upon deforming to the memorized shape, the wire is misaligned relative to a remaining portion of the deformable element.

8. The battery system of claim 1, wherein the pre-stressed shape is a natural resting shape of the deformable element that is retained by the deformable element at ambient temperature and pressure conditions.

9. The battery system of claim 1, wherein the predefined temperature threshold is greater than ambient temperature conditions and lies in a range of 80° C. (C) to 110° C.

10. The battery system of claim 9, wherein the predefined temperature threshold lies in a range of 80° C. to 85° C., 85° C. to 90° C., 90° C. to 95° C., or 95° C. to 100° C.

11. A sensor for indicating an adverse thermal event in a cell, the sensor comprising:
a deformable element made of a shape-memory material (SMM) and has a pre-stressed shape, wherein:
the deformable element is formed as a wire,
the deformable element is adapted to deform to a memorized shape from the pre-stressed shape in response to an operating temperature of the cell exceeding a predefined temperature threshold for the cell,
the memorized shape of the deformable element is different from the pre-stressed shape of the deformable element, and
a deformity of the deformable element from the pre-stressed shape to the memorized shape is indicative of the adverse thermal event in the cell.

12. The sensor of claim 11, wherein the adverse thermal event in the cell is indicated based on a visual inspection of the deformity of the deformable element to the memorized shape.

13. The sensor of claim 11, wherein the memorized shape is a curvilinear shape, a hook shape, or a U-shape.

14. The sensor of claim 11, wherein the sensor includes:
a substrate to mechanically couple the sensor to an outer surface of a housing of the cell, wherein the deformable element is in contact with the substrate;
a conductive wire that contacts the deformable element, wherein the conductive wire defines a fuse segment, a first electrode, and a second electrode, and wherein the deformable element is adapted to break the fuse segment based on the deformity of the deformable element to the memorized shape;
a first coupling element to couple the conductive wire with the substrate;
a second coupling element to couple the deformable element with the conductive wire at a first end of the deformable element, wherein the fuse segment is defined between the first coupling element and the second coupling element;
a third coupling element to couple the deformable element with the substrate at a second end of the deformable element, wherein the second end is defined opposite the first end; and
a thermally conductive agent disposed around the deformable element to retain the deformable element in contact with the substrate.

15. The sensor of claim 14 further comprising a controller, wherein the first electrode and the second electrode are in communication with the controller, and wherein the controller is configured to measure an electrical resistance across the fuse segment to indicate the adverse thermal event in the cell.

16. The sensor of claim 11, wherein the SMM of the deformable element is a shape-memory alloy (SMA).

17. A method for indicating an adverse thermal event in a cell, the method comprising:
coupling a sensor, including a deformable element made of a shape- memory material (SMM), to an outer surface of a housing of the cell, wherein at least a segment of the deformable element is formed as a wire, and wherein the deformable element has a pre-stressed shape;
deforming the deformable element to a memorized shape from the pre-stressed shape when an operating temperature of the cell exceeds a predefined temperature threshold for the cell, wherein the memorized shape of the deformable element is different from the pre-stressed shape of the deformable element; and
indicating the adverse thermal event in the cell based on a deformity of the deformable element from the pre-stressed shape to the memorized shape.

18. The method of claim 17 further comprising:
coupling the sensor to the outer surface of the housing using a substrate of the sensor, wherein the deformable element is coupled to the substrate.

19. The method of claim 17, wherein the sensor includes a conductive wire that contacts the deformable element, and wherein the conductive wire defines a fuse segment, a first electrode, and a second electrode, the method further comprising:
breaking, by the deformable element, a fuse segment based on the deformity of the deformable element from the pre-stressed shape S1 to the memorized shape.

20. The method of claim 18 further comprising:
indicating the adverse thermal event in the cell based on at least one of a visual inspection of the deformity of the deformable element to the memorized shape and measuring, by a controller, an electrical resistance across the fuse segment to indicate the adverse thermal event in the cell.
